(19) United States
(12) Patent Application Publication
(10) Pub. No.: US 2026/0149120 A1
(43) Pub. Date: May 28, 2026

(54) STRUCTURAL VENT CHANNEL FOR RECHARGEABLE ENERGY STORAGE SYSTEM OF VEHICLE

(71) Applicant: GM GLOBAL TECHNOLOGY OPERATIONS LLC, DETROIT, MI (US)

(72) Inventors: Ryan Patrick Hickey, Austin, TX (US); Phillip Daniel Hamelin, Holly, MI (US); Alexander M. Bilinski, Avoca, MI (US)

(21) Appl. No.: 18/960,085

(22) Filed: Nov. 26, 2024

(51) Int. Cl. H01M 50/375; B60L 50/64; H01M 50/204; H01M 50/271; H01M 50/358

(52) U.S. Cl. CPC H01M 50/375; B60L 50/64; H01M 50/204; H01M 50/271; H01M 50/358; H01M 2220/20

(57) ABSTRACT

A rechargeable energy storage system (RESS) of a vehicle includes a plurality of battery cells. The plurality of battery cells includes a plurality of vent passages to exhaust hot vent gas from the plurality of battery cells. A cell bridge is positioned over the plurality of vent passages. The cell bridge includes a wire mesh and a plastic material. A vehicle includes a vehicle body, a powertrain positioned in the vehicle body, and a rechargeable energy storage system (RESS) operably connected to the powertrain. The RESS includes a plurality of battery cells, and the plurality of battery cells includes a plurality of vent passages to exhaust hot vent gas from the plurality of battery cells. A cell bridge is positioned over the plurality of vent passages. The cell bridge includes a wire mesh and a plastic material.

The subject disclosure relates to vehicles, and in particular to rechargeable energy storage systems (RESS) for vehicles.

Many vehicles include RESS structures to provide power to, for example, propulsion systems of the vehicle. RESS structures typically include a plurality of battery cells arranged as a battery pack and contained in a housing, that includes a housing cover. Under certain conditions, the battery cells may release high temperature gas (i.e., vent gas from a battery cell) and particles. In some configurations, it is desired to structurally connect the battery pack to the cover for structural support of the cover. It is however, also required to vent the high temperature gas from the battery pack, as well as contain particle debris from the battery pack during a high temperature event.

### SUMMARY

In one exemplary embodiment, a rechargeable energy storage system (RESS) of a vehicle includes a plurality of battery cells. The plurality of battery cells includes a plurality of vent passages to exhaust hot vent gas from the plurality of battery cells. A cell bridge is positioned over the plurality of vent passages. The cell bridge includes a wire mesh and a plastic material.

In addition to one or more of the features described herein the plastic material is configured to melt when exposed to temperatures greater than 150 degrees Celsius.

In addition to one or more of the features described herein the wire mesh is configured to contain particles greater than a predetermined threshold size in a vent passage defined between the cell bridge and the plurality of battery cells.

In addition to one or more of the features described herein the predetermined threshold size is a 0.9 millimeter effective diameter.

In addition to one or more of the features described herein the cell bridge is connected to and supportive of a cover of the RESS.

In addition to one or more of the features described herein the cell bridge is secured to the cover via an adhesive layer.

In addition to one or more of the features described herein the wire mesh is a steel material.

In addition to one or more of the features described herein a plurality of leg openings are formed in the plastic material.

In addition to one or more of the features described herein the wire mesh material extends through the plurality of leg openings.

In addition to one or more of the features described herein the cell bridge is formed by overmolding the plastic material over the wire mesh.

In another exemplary embodiment, a vehicle includes a vehicle body, a powertrain positioned in the vehicle body, and a rechargeable energy storage system (RESS) operably connected to the powertrain. The RESS includes a plurality of battery cells, and the plurality of battery cells includes a plurality of vent passages to exhaust hot vent gas from the plurality of battery cells. A cell bridge is positioned over the plurality of vent passages. The cell bridge includes a wire mesh and a plastic material.

In addition to one or more of the features described herein the plastic material is configured to melt when exposed to temperatures greater than 150 degrees Celsius.

In addition to one or more of the features described herein the wire mesh material is configured to contain particles greater than a predetermined threshold size in a vent passage defined between the cell bridge and the plurality of battery cells.

In addition to one or more of the features described herein the predetermined threshold size is a 0.9 millimeter effective diameter.

In addition to one or more of the features described herein the cell bridge is connected to and supportive of a cover of the RESS.

In addition to one or more of the features described herein the cell bridge is secured to the cover via an adhesive layer.

In addition to one or more of the features described herein the wire mesh is a steel material.

In addition to one or more of the features described herein a plurality of leg openings are formed in the plastic material.

In addition to one or more of the features described herein the wire mesh extends through the plurality of leg openings.

In addition to one or more of the features described herein the cell bridge is formed by overmolding the plastic material over the wire mesh material.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic illustration of an embodiment of a vehicle;

FIG. 2 is a cross-sectional illustration of a rechargeable energy storage system (RESS) of a vehicle including a plurality of battery cells;

FIG. 3 is a cross-sectional view of an embodiment of a cell bridge of an RESS;

FIG. 4 is perspective view of an embodiment of a cell bridge of an RESS;

FIG. 4A is a cross-sectional view of another embodiment of a cell bridge of an RESS;

FIG. 4B is a cross-sectional view of yet another embodiment of a cell bridge of an RESS; and

FIG. 5 is another cross-sectional illustration of an RESS of a vehicle.

### DETAILED DESCRIPTION

The following description is merely exemplary in nature and is not intended to limit the present disclosure, its application or uses. It should be understood that throughout the drawings, corresponding reference numerals indicate like or corresponding parts and features.

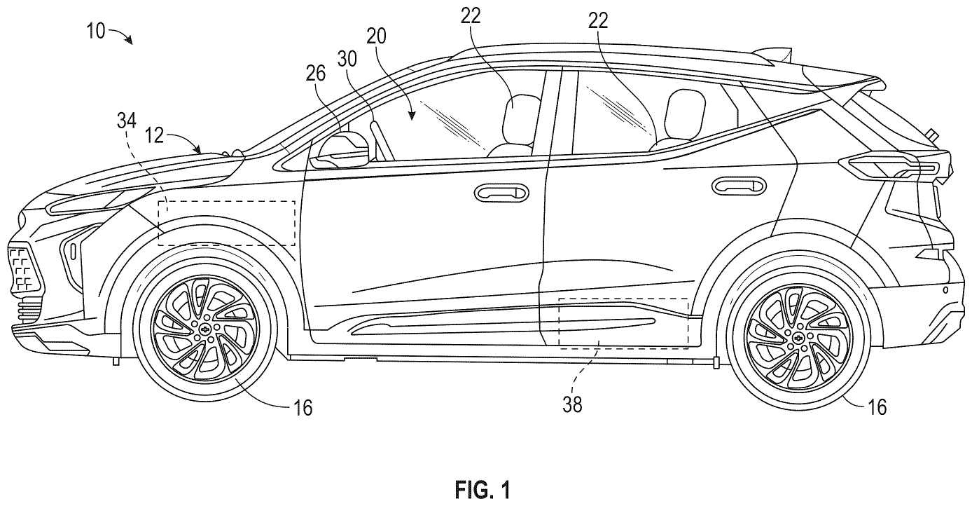

In accordance with an exemplary embodiment a vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. Body 12 defines, in part, a passenger compartment 20 having seats 22 positioned behind a dashboard 26. A steering control 30 is arranged between seats 22 and dashboard 26. Steering control 30 is operated to control orientation of the steerable wheel(s). Vehicle 10 includes a powertrain including for example, an electric motor 34 connected to a transmission that provides power to one or more of the plurality of wheels 16. A rechargeable energy storage system (RESS) assembly 38 provides power to the electric motor 34.

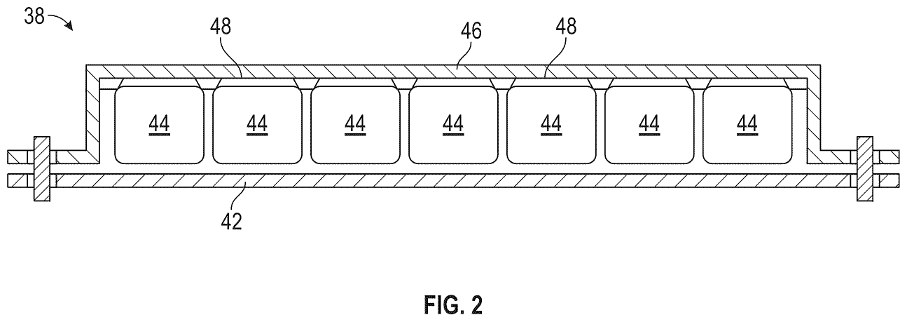

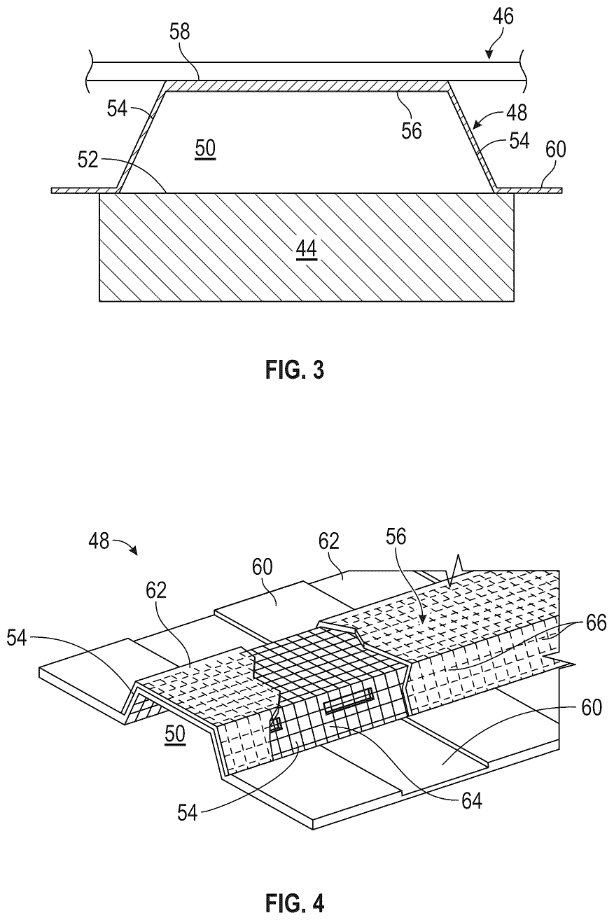

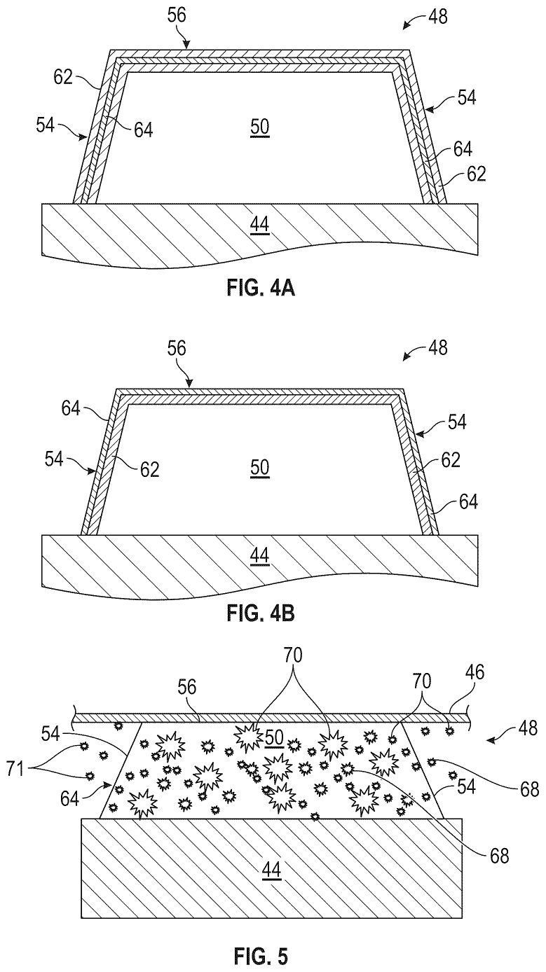

Referring now to FIG. 2, illustrated is a cross-sectional view of an exemplary embodiment of an RESS assembly 38. The RESS assembly 38 includes a tray 42 with a plurality of cells 44 disposed therein. To enclose the RESS assembly 38, a cover 46 is installed thereon. As illustrated in FIG. 3, a cell bridge 48 is provided between the cells 44 and the cover 46 to provide structural support for the cover 46 during normal operation of the vehicle 10. The cell bridge 48 spans a vent passage 50 between a cell top 52 of the battery cell 44 and the cover 46, and includes a two bridge legs 54 extending from the battery cells 44 toward a bridge cap 56, which is connected to the cover 46. In some embodiments, the bridge cap 56 is connected to the cover 46 by an adhesive layer 58. In some embodiments, such as shown in FIG. 4, the cell bridge 48 further includes one or more bridge bases 60 from which the bridge legs 54 extend.

The cell bridge 48 is formed from a low-temperature plastic material 62 overmolded over a metallic wire mesh 64, which is formed from, for example, a steel material. In some embodiments, the overmolding is performed via one or more injection molding processes. One skilled in the art, however, will readily appreciate that this process is merely exemplary and that other molding processes may be utilized. Additionally, in some embodiments the wire mesh 64 is enclosed in the plastic material 62, while in other embodiments, such as in FIGS. 4A and 4B, the wire mesh 64 and the plastic material are separate layers joined together to form the cell bridge 58.

The plastic material 62 is configured to melt at temperatures exceeding, for example, 150 degrees Celsius, while the wire mesh 64 is configured to withstand temperatures encountered during a thermal event of the RESS assembly 38, for example, temperatures in the range of 400-1200 degrees Celsius. In some embodiments, the entire cell bridge 48 is formed from the wire mesh 64 overmolded by the plastic material 62, while in other embodiments, only portions of the cell bridge 48, such as the bridge legs 54 and/or the bridge cap 56 are formed with this configuration. As shown in FIG. 4, the bridge legs 54 may include one or more leg openings 66 in the plastic material 62 with, in some embodiments, the wire mesh 64 extends across the leg openings 66. Inclusion of the leg openings 66 allows for rapid depressurization in the vent passage 50 between the cell bridge 48 and the battery cells 44 during the early stage of a thermal event so that the plastic material 62 can quickly melt.

Referring now to FIG. 5, illustrated schematically is the cell bridge 48 during a thermal event. In such an event, the plastic material 62 is melted away due to the elevated temperature, ang the wire mesh 64 remains between the cover 46 and the cells 44. During a thermal event, the wire mesh 64 allows vent gasses 68 to pass through the wire mesh 64, while preventing particles 70 ejected from the battery cells 44 that exceed a preselected threshold size from passing through the wire mesh 64. In some embodiments, the wire mesh is configured to prevent particles 70 with effective diameters greater than, for example, 0.9 millimeters, from passing through the wire mesh 64. Particles 71 smaller than the predetermined threshold size are free to pass through the wire mesh 64. The wire mesh 64 may be configured to break larger particles 70 that exceed the threshold size into particles 71 that do not exceed the threshold size via impact of the particles 70 with the wire mesh 64. Therefore when the plastic material 62 is melted during onset of a thermal event, the wire mesh 64 remains in place to allow vent gasses 68 to escape and to prevent egress of large particles 70 from the vent passage 50. This containment lowers arcing risk near high voltage elements of the cells 44.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A rechargeable energy storage system (RESS) of a vehicle, comprising:
a plurality of battery cells, the plurality of battery cells including a plurality of vent passages to exhaust hot vent gas from the plurality of battery cells; and
a cell bridge disposed over the plurality of vent passages, the cell bridge comprising a wire mesh and a plastic material.

2. The RESS of claim 1, wherein the plastic material is configured to melt when exposed to temperatures greater than 150 degrees Celsius.

3. The RESS of claim 1, wherein the wire mesh is configured to contain particles greater than a predetermined threshold size in a vent passage defined between the cell bridge and the plurality of battery cells.

4. The RESS of claim 3, wherein the predetermined threshold size is a 0.9 millimeter effective diameter.

5. The RESS of claim 1 wherein the cell bridge is connected to and supportive of a cover of the RESS.

6. The RESS of claim 5, wherein the cell bridge is secured to the cover via an adhesive layer.

7. The RESS of claim 1, wherein the wire mesh is a steel material.

8. The RESS of claim 1, wherein a plurality of leg openings are formed in the plastic material.

9. The RESS of claim 8, wherein the wire mesh extends through the plurality of leg openings.

10. The RESS of claim 1, wherein the cell bridge is formed by overmolding the plastic material over the wire mesh.

11. A vehicle, comprising:
a vehicle body;
a powertrain disposed in the vehicle body; and
a rechargeable energy storage system (RESS) operably connected to the powertrain, the RESS including:
a plurality of battery cells, the plurality of battery cells including a plurality of vent passages to exhaust hot vent gas from the plurality of battery cells; and
a cell bridge disposed over the plurality of vent passages, the cell bridge comprising a wire mesh and a plastic material.

12. The vehicle of claim 11, wherein the plastic material is configured to melt when exposed to temperatures greater than 150 degrees Celsius.

13. The vehicle of claim 11, wherein the wire mesh material is configured to contain particles greater than a predetermined threshold size in a vent passage defined between the cell bridge and the plurality of battery cells.

14. The vehicle of claim 13, wherein the predetermined threshold size is a 0.9 millimeter effective diameter.

15. The vehicle of claim 11 wherein the cell bridge is connected to and supportive of a cover of the RESS.

16. The vehicle of claim 15, wherein the cell bridge is secured to the cover via an adhesive layer.

17. The vehicle of claim 11, wherein the wire mesh is a steel material.

18. The vehicle of claim 11, wherein a plurality of leg openings are formed in the plastic material.

19. The vehicle of claim 18, wherein the wire mesh material extends through the plurality of leg openings.

20. The vehicle of claim 11, wherein the cell bridge is formed by overmolding the plastic material over the wire mesh.
